(19) United States
(12) Patent Application Publication
(10) Pub. No.: US 2022/0080766 A1
(43) Pub. Date: Mar. 17, 2022

(54) Cylindrical Pen Holder for Sticky Notes

(71) Applicant: JOUR CHAR-TER, Taipei City (TW)

(72) Inventor: JOUR CHAR-TER, Taipei City (TW)

(21) Appl. No.: 17/020,832

(22) Filed: Sep. 15, 2020

(51) Int. Cl. B43K 23/00; B42D 5/00

(52) U.S. Cl. CPC B43K 23/001; B42D 5/005

(57) ABSTRACT

The present invention relates generally to a cylindrical pen holder for sticky notes, which can be placed on table top for leaving messages and holding different kinds of pens. The cylindrical pen holder for sticky notes is a cylinder composed of a first case and a second case. At least a set of opposite openings is made in the circumference of the cylinder. A set of colored consecutive self-adhesive notepaper is provided under each opening, and the free end of the first self-adhesive notepaper penetrates out of the opening for convenient extraction. When a sticky note of the consecutive self-adhesive notepaper set is drawn out, the next sheet comes out with it, and the free end of the following sticky note is exposed out of the opening. When the sticky notes are used up, the first case and the second case can be opened to supplement the sticky note set.

### BACKGROUND OF INVENTION

### 1. Field of the Invention

The present invention relates generally to a cylindrical pen holder for sticky notes, providing multiple sets of self-adhesive notepaper for recording things or leaving words, as well as holding different kinds of pens, and the self-adhesive notepaper can be supplemented.

### 2. Description of Related Art

Sticky note is one of common personal office supplies, for the user to record real-time information or important memos at any time. The common sticky notes comprise multiple paper sheets stacked up, and viscous back adhesive is partially applied to the edge of bottom surface of each paper on the same side of the multiple paper sheets, so as to implement sticking positioning of the paper.

As the sticky note can be torn down immediately after writing and affixed anywhere to remind the user, it is accepted by most people. However, it is found in long-term use that if a user tears down a sticky note quickly, a part of unused sticky notes is often taken down at the same time, when these dropped unused sticky notes are stuck back on the other part of unused sticky notes, the viscosity has weakened, and it is unlikely to take one single sticky note, the user has to press the note with one hand and tear it down with the other hand, that is inconvenient for the user. Secondly, the sticky note shall be provided with a pen for recording things. Sometimes a user feels embarrassed when he cannot find a pen for temporary records on an emergency call. In addition, one single set of sticky notes is hard for classification, sometimes the user would like to classify messages, general or important things, but the notes are in one color, failing to implement classification, it is undoubtedly an inconvenience to the users.

### SUMMARY OF THE INVENTION

In view of this, the fundamental purpose of the present invention is to provide a cylindrical pen holder for sticky notes, which provides sticky note sets in at least two different colors for classification, and holds different kinds of pens.

To attain the aforesaid purpose, the present invention designs a cylindrical pen holder for sticky notes, which has a cylindrical main body, comprising a first case and a second case symmetric to each other (upper and lower cases or left and right cases). The opposite faces of the first case and the second case are provided with a set of plug hole and slot in the center of circle, a set of opposite bonding columns and bonding slots for combination within the circumferential faces of the set of plug hole and slot, a plurality of storage slots for placing the stacked sticky note set on the outer circumference of the plug hole and slot, and at least two opposite openings in the circumferences of the first and second cases. A part of one sticky note is exposed out of the opposite openings respectively for the user to draw, and a plug hole is located in the center of circle of main body for inserting any kind of pen, so that the user can use the pen and sticky notes for recording at any time.

Each of the aforementioned sticky note sets comprises multiple sticky notes stacked up, and the adhesive is partially applied to the head and tail of every sticky note alternately. When a sticky note is drawn out, its tail draws the head of next sticky note out of the opening, so as to implement continuous use. When the whole sticky note set is used up, the first case can be separated from the second case for supplementation.

The first and second cases forming the main body can be made of transparent, semi-transparent or non-transparent material.

The shape of the aforementioned main body is not limited to cylinder, any combination pattern of the first and second cases in any geometric shapes and distributed symmetrically is acceptable.

Each of the aforesaid sticky note sets can be given different colors or shapes.

### BRIEF DESCRIPTION OF THE DRAWINGS

FIG. 1 is the case combination in a preferred embodiment of the present invention.

FIG. 2 is the exploded diagram of cases in a preferred embodiment of the present invention.

FIG. 3 is the exploded diagram of complete structure in a preferred embodiment of the present invention.

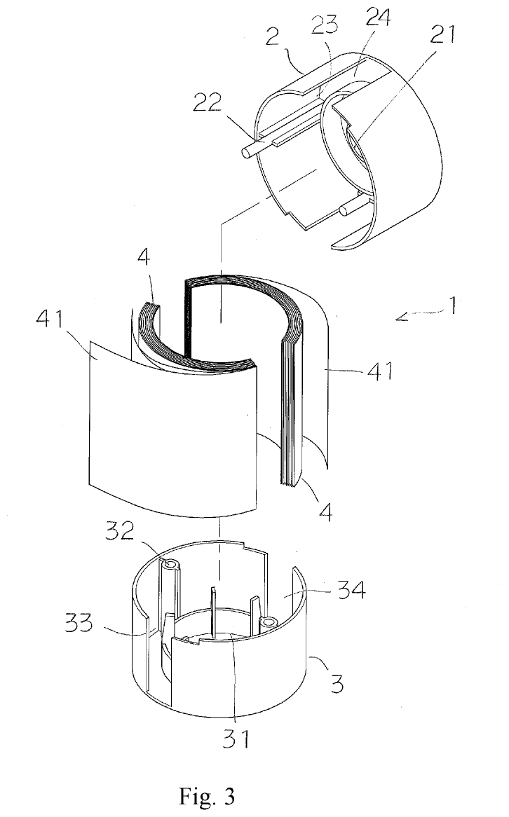

FIG. 4 is the combined diagram of complete structure in a preferred embodiment of the present invention.

FIG. 5 is the sectional view based on FIG. 4.

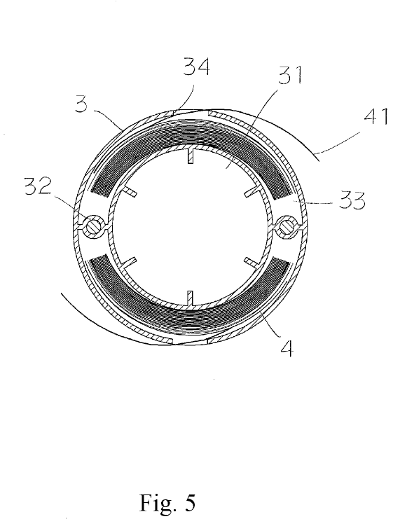

FIG. 6 is schematic diagram of continuous action based on FIG. 5.

FIG. 7 is the schematic diagram of operating state in a preferred embodiment of the present invention.

### DETAILED DESCRIPTION OF THE INVENTION

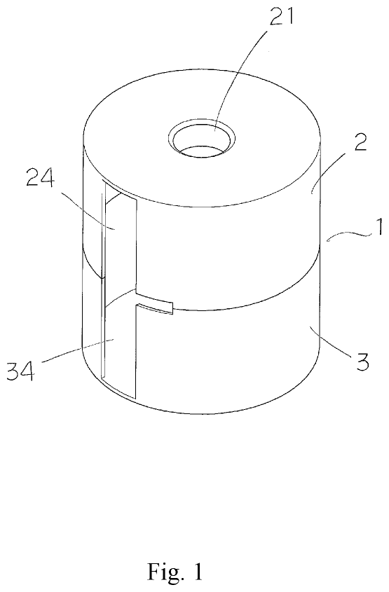

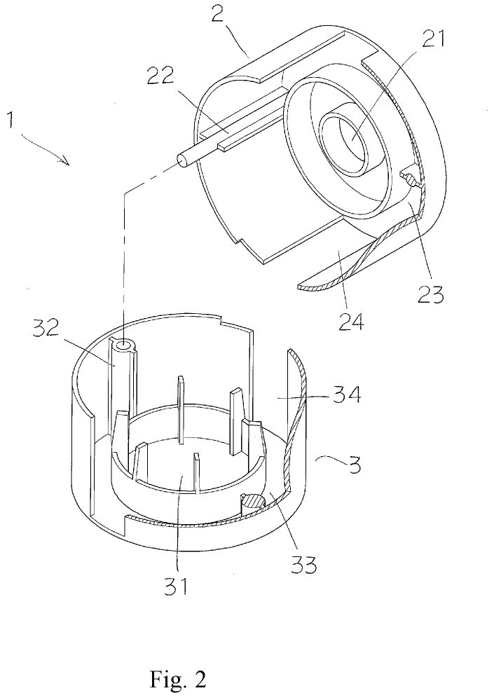

FIG. 1 and FIG. 2 are the exploded diagram and combined diagram of cylindrical main body structure in a preferred embodiment of the present invention, wherein the main body (1) comprises two symmetrically shaped first case (2) and second case (3), which can be implemented by symmetrically shaped upper and lower or left and right cases.

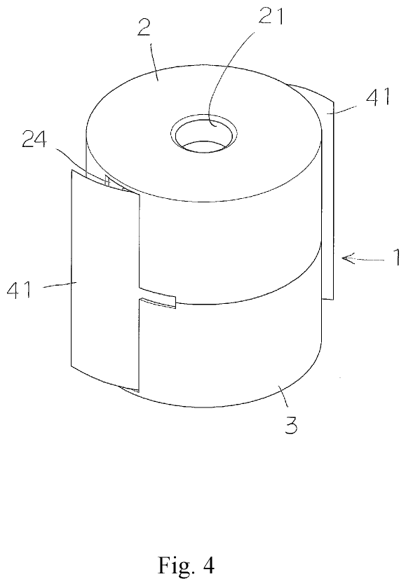

As shown in FIG. 1˜FIG. 4, the opposite faces of the first case (2) and the second case (3) are provided with a plug hole (21) and a slot (31) in the center of circle of the main body (1) respectively, the hole size of the plug hole (21) can be smaller than or almost equal to the size of the slot (31), in implementation, when the hole size of plug hole (21) is small, one pen can be inserted in the hole, when the hole size of plug hole (21) is large, 2˜3 pens can be inserted in the hole. A set of bonding column (22) and bonding slot (32) for combination on the outer circumference of the plug hole (21) and slot (31), and a plurality of storage slots (23, 33) for placing the stacked sticky note set (4) on the outer circumference of the plug hole (21) and slot (31), the bonding column (22) is integrated with the bonding slot (32), and in implementation, the bonding column (22) of the first case (2) and the bonding slot (32) of the second case (3) can be interchanged, meaning the first case (2) has the bonding slot (32) and the second case (3) has the bonding column (22), and the two storage slots (23, 33) can hold a large sized sticky note set (4) jointly, in implementation, two small sized sticky note sets (4) can be placed side by side. A set of opposite openings (24, 34) in the circumferences of the first case (2) and the second case (3) for exposing a part of one sticky note (41) for convenient extraction, in implementation, the size of the openings (24, 34) can coordinate with the size of the sticky note set (4), e.g. one to one (equivalent sizes), meaning one sticky note set (4) corresponds to a set of opposite openings (24, 34), or two to one (smaller size of sticky note), two sticky note sets (4) exactly correspond to a set of opposite openings (24, 34), by analogy, as long as the quantity or size of corresponding openings (24, 34) is increased, the quantity of sticky note set (4) can be increased, once the quantity of the sticky note set (4) increases, in implementation, each sticky note set (4) can be given a different color or shape, thus, it is more convenient for the users to classify records.

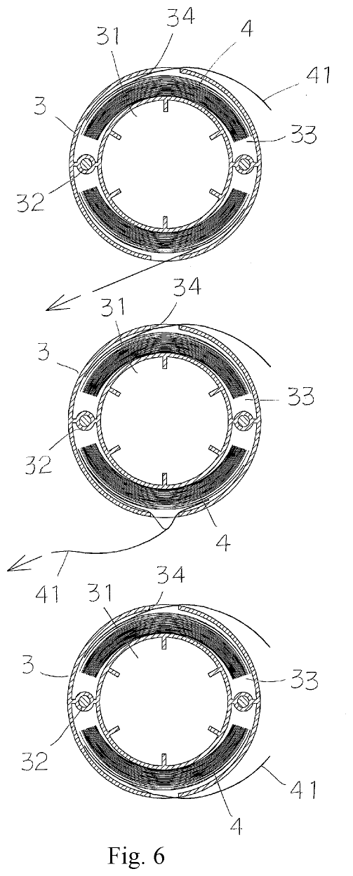

As shown in FIG. 4˜FIG. 6, it is observed in the outside and section views that a sticky note (41) is exposed out of the openings (24, 34) on opposite sides of main body (1) of the cylindrical pen holder for sticky notes respectively for the user to take. The sticky note set (4) comprises multiple sticky notes stacked up, and the adhesive is partially applied to the head and tail of every sticky note (41) alternately. As shown in the schematic diagram of consecutive action, when the exposed single sticky note (41) is drawn out, its tail draws one end of a sticky note (41) automatically and the extraction direction is changed. On the one hand, the user is provided with operation benefit of continuous extraction, on the other hand, the operation mode is a little interesting. The sticky note (41) is supplemented after exhaustion.

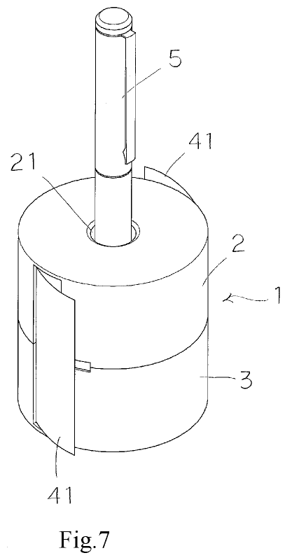

As shown in FIG. 7, besides sticky notes (41), the main body (1) provides a plug hole (21) for pen (5), the hole size of the plug hole (21) shown in the figure exactly allows one pen (5). Certainly, if the size of plug hole (21) is increased, it can hold 2˜3 pens (5) at a time.

The first case (2) and the second case (3) of the main body (1) of the present invention can be made of transparent, semi-transparent or non-transparent material, so as to diversify the particular style of the cylindrical main body (1). The shape of the main body (1) of the cylindrical pen holder for sticky notes is not limited to cylinder, any combination pattern of two symmetric cases in any geometric shapes is acceptable.

Although the invention has been explained in relation to its preferred embodiment, it is to be understood that many other possible modifications and variations can be made without departing from the spirit and scope of the invention as hereinafter claimed.

1. A cylindrical pen holder for sticky notes has a cylindrical main body, which comprises symmetrically shaped first and second cases. The opposite faces of the first and second cases are provided with
a set of plug hole and slot, located in the center of circle of the first and second cases for holding a pen;
a set of bonding column and bonding slot, located in opposite positions on outer circumference of the plug hole and slot of the first and second cases for combination;
a plurality of storage slots, located in the outer circumference of plug hole and slot of the first and second cases for placing the sticky note set; and
a plurality of openings in opposite positions of circumference of the first and second cases.

2. The cylindrical pen holder for sticky note defined in claim 1, wherein the sticky note set comprises multiple sticky notes stacked up, and the adhesive is partially applied to the head and tail of every sticky note alternately.

3. The cylindrical pen holder for sticky note defined in claim 1, wherein the first and second cases which form the main body can be made of transparent, semi-transparent or non-transparent material.

4. The cylindrical pen holder for sticky note defined in claim 1, wherein the main body can be any combination pattern of two symmetric cases in any geometric shapes.

5. The cylindrical pen holder for sticky note defined in claim 1, wherein each sticky note set can be given a different color or shape.
